(19) United States
(12) Patent Application Publication
(10) Pub. No.: US 2013/0226999 A1
(43) Pub. Date: Aug. 29, 2013

(54) METHOD, SYSTEM AND PROGRAM PRODUCT FOR INTERACTION BETWEEN USERS

(71) Applicant: Mike Sarieddine, Woodland Hills, CA (US)

(72) Inventor: Mike Sarieddine, Woodland Hills, CA (US)

(21) Appl. No.: 13/775,184

(22) Filed: Feb. 23, 2013

Related U.S. Application Data
(60) Provisional application No. 61/634,049, filed on Feb. 23, 2012.

(51) Int. Cl. H04L 29/06

(52) U.S. Cl. CPC H04L 29/06047
USPC 709/203

(57) ABSTRACT

A method, system and program product comprises establishing a communication with a server. A location of a user is transmitted to the server. A user's question is transferred to the server. The question comprises text and at least one multimedia component. The server is configured to be operable for enabling other users, located within a predetermined distance from the location, to receive the question and to post a reply to the question. The server is further configured to be operable for storing replies to the question and sending at least one notification to the user that replies have been received.

### CROSS-REFERENCE TO RELATED APPLICATIONS

The present Utility patent application claims priority benefit of the U.S. provisional application for patent Ser. No. 61/634,049 entitled filed on Feb. 23, 2012 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to internet services. More particularly, the invention relates to interaction between users of the internet.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The internet provides users with an almost limitless supply of information. However, many find it frustrating and difficult to find reliable answers online to their specific questions.

A currently known solution provides services that facilitate interaction between users who supply questions and users who supply responses to the questions of other users, as well as using the generated content in various ways. However, this solution does not allow users to restrict responses based on the locations of other users. Another currently known solution provides a method and system of providing a response from a local source to a query placed in a query box, and locates the respondent who is geographically closest to the person who placed the query. However, this solution does not allow users to ask questions in the form of video, audio, or image. An approach that allowed for services based on location as well as uploading questions and responses in the form of text as well as in the form of video, audio, and/or image would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram depicting an exemplary regionalized client/server communication system supporting location aware capabilities, in accordance with an embodiment of the present invention;

FIG. 2 illustrates an exemplary process by which a user may access the software to ask a question, in accordance with an embodiment of the present invention;

FIG. 3 illustrates an exemplary process by which a user may access the software to answer a question, in accordance with an embodiment of the present invention;

FIG. 4A is an illustration of an exemplary first screen of a registration process, by which users may register to use the software, in accordance with an embodiment of the present invention;

FIG. 4B is an illustration of an exemplary second screen of the registration process, in accordance with an embodiment of the present invention;

FIG. 5 is an illustration of an exemplary home screen, in accordance with an embodiment of the present invention:

FIG. 6 is an illustration of an exemplary popup menu screen, in accordance with an embodiment of the present invention;

FIG. 7 is an illustration of an exemplary screen for showing a detailed view of a question, in accordance with an embodiment of the present invention;

FIG. 8 is a block diagram depicting an exemplary client/server system which may be used by an exemplary web-enabled/networked embodiment of the present invention; and

FIG. 9 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer, a mini-computer; a workstation; a micro-computer, a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments of the present invention provide means and methods for facilitating communication on the internet through use of a mobile application, website, or any other means of accessing the internet. Software for at least some embodiments may be coded for all mobile phone operating systems. In many embodiments, a user may access the software to ask and/or answer questions, and also to view or hear questions and responses from other users of the software.

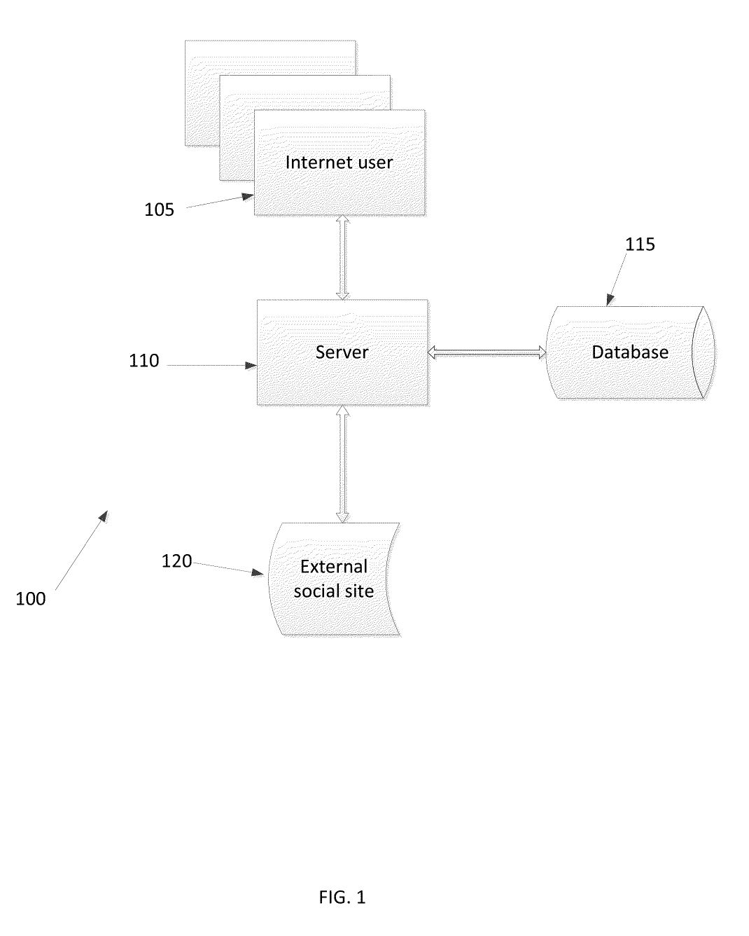

FIG. 1 illustrates a block diagram depicting an exemplary regionalized client/server communication system supporting location aware capabilities, in accordance with an embodiment of the present invention. In the present embodiment, an internet user 105 may connect to the internet by means of any device, including, without limitation, a computer, mobile device, or tablet. The device may connect bi-directionally with a server 110 via a web service or HTTP call. Through this connection, the device may send any data to the server that may be relevant for embodiments of the present invention. The device may also communicate its location to the server by means such as, but not limited to, global positioning systems (GPS), Wi-Fi location, or any type of radio frequency locating signal including but not limited to, radio frequency identity devices (RFID). In other embodiments, the device may connect to the server 110 via a local internet connection such as, but not limited to a wireless local area network (WLAN) or Wi-Fi hotspot. The server may also transfer data bi-directionally with a database 115, through which process the server may transfer information stored in the database to users of the internet. In some embodiments, the server may also communicate bi-directionally with external social sites 120, through which process information stored in the database may be shared with the external social sites.

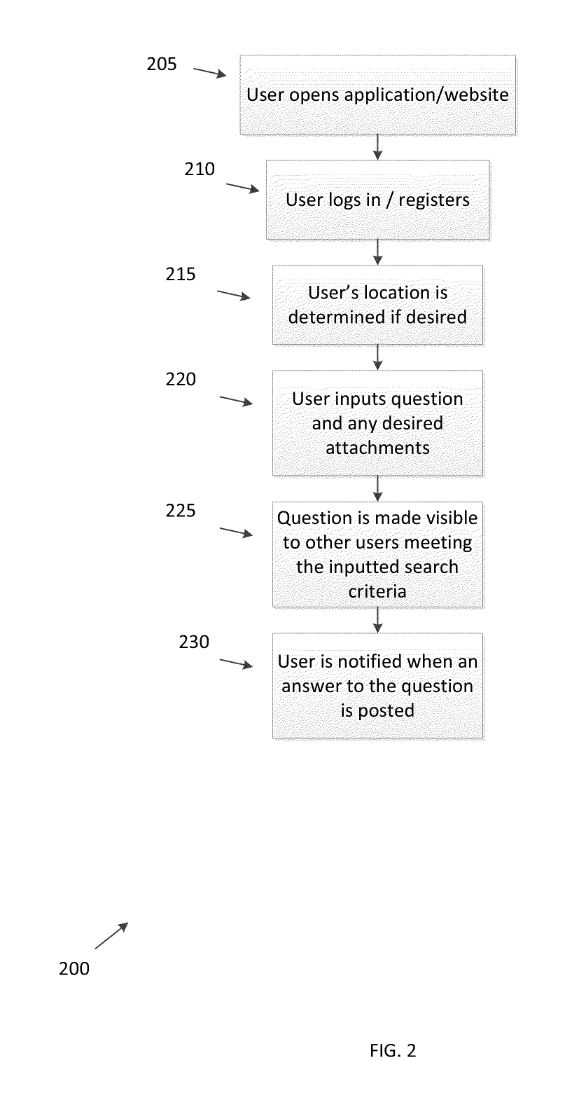

FIG. 2 illustrates an exemplary process by which a user may access the software to ask a question, in accordance with an embodiment of the present invention. In the present non-limiting example, users may access the software by means of a website or a mobile application in a step 205. In some embodiments, users may be required to be register with the software, in which case a user may be prompted to register or log in after opening the software in a step 210. In alternative embodiments, users may access the software through means of a temporary account, in which case a user may not need to be registered with the software. In some embodiments, a user's location may be determined for use by the software in a step 215. A user's location may be determined by any means, including, without limitation, a global positioning system (GPS) or manual input by the user. After accessing the software, users may input questions that may be shown to other users in a step 220. In some embodiments, questions may be inputted in any multimedia format, including, without limitation, text, audio, video, and picture. Questions may be inputted in a single form or in a combination of multiple forms. After a user posts a question, it may become visible through use of the software to other users, as shown in a step 225. In some embodiments, users may specify search criteria to exclude certain users from viewing the user's posted question. In some embodiments, a user may be notified when another user has responded to the user's posted question, as shown in a step 230. Users may be notified by any means, including, without limitation, email, text message, or an alert through the software.

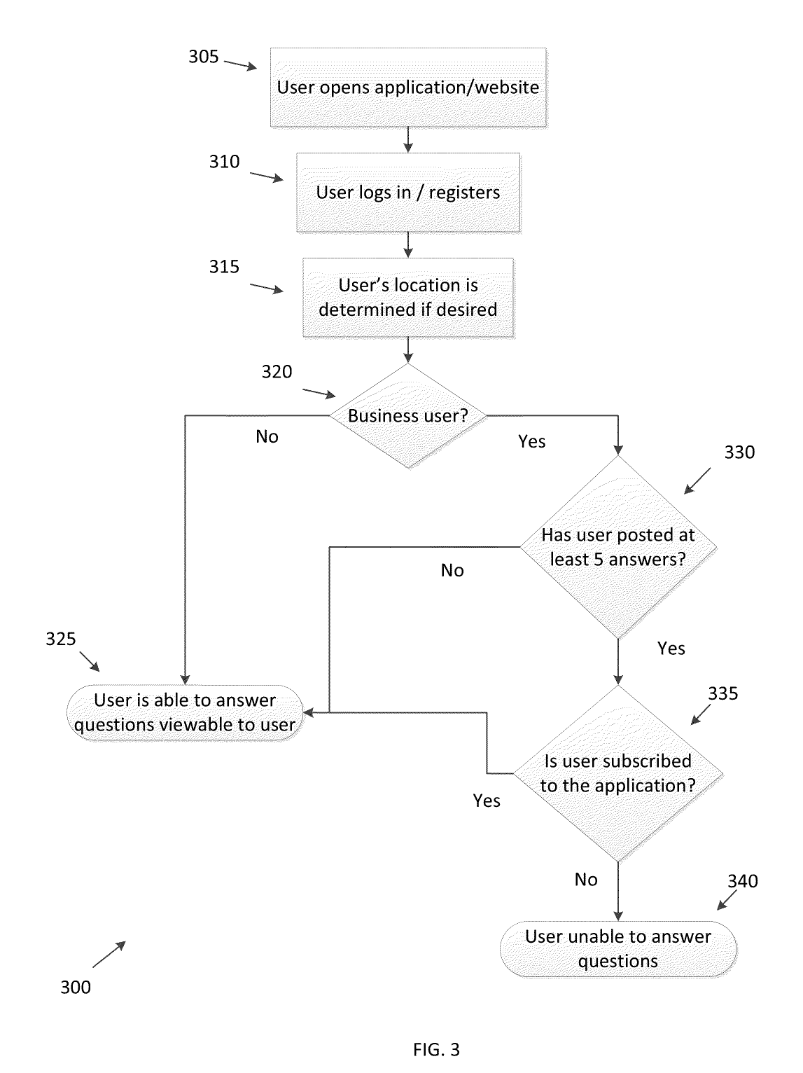

FIG. 3 illustrates an exemplary process by which a user may access the software to answer a question, in accordance with an embodiment of the present invention. In the present non-limiting example, users may access the software by means of a website or a mobile application in a step 305. Users may be prompted to register or log in to the system in a step 310. A user's location may be determined in a step 315. In some embodiments, a user may be required to be classified as either a business or non-business user in a step 320. If a user is a non-business user, the user may be enabled to respond to questions in the software that are viewable to the user in a step 325. In some embodiments, if a user is a business user, the user may be required to subscribe to the software on a monthly or yearly basis in order to post more than five answers using the software, as shown in a step 330. If a user is a business user and has not posted more than five answers using the software, the user is enable to respond to questions in the software that are viewable to the user in a step 325. If a user is a business user and has answered more than five questions using the software, the user may only be enabled to continue answering questions using the software if the user is subscribed to the software on a monthly or yearly basis, as shown in a step 335, otherwise the user may not respond to questions through the software in a step 340. In some alternative embodiments, business users may be enabled to respond to any number of questions before subscribing to the software. In other alternative embodiments, a business user may be enabled to respond to an unlimited number of questions with any kind of subscription, including, without limitation, a daily or weekly subscription. In yet other alternative embodiments, business users may be enabled to respond to an unlimited number of questions without being subscribed to the software.

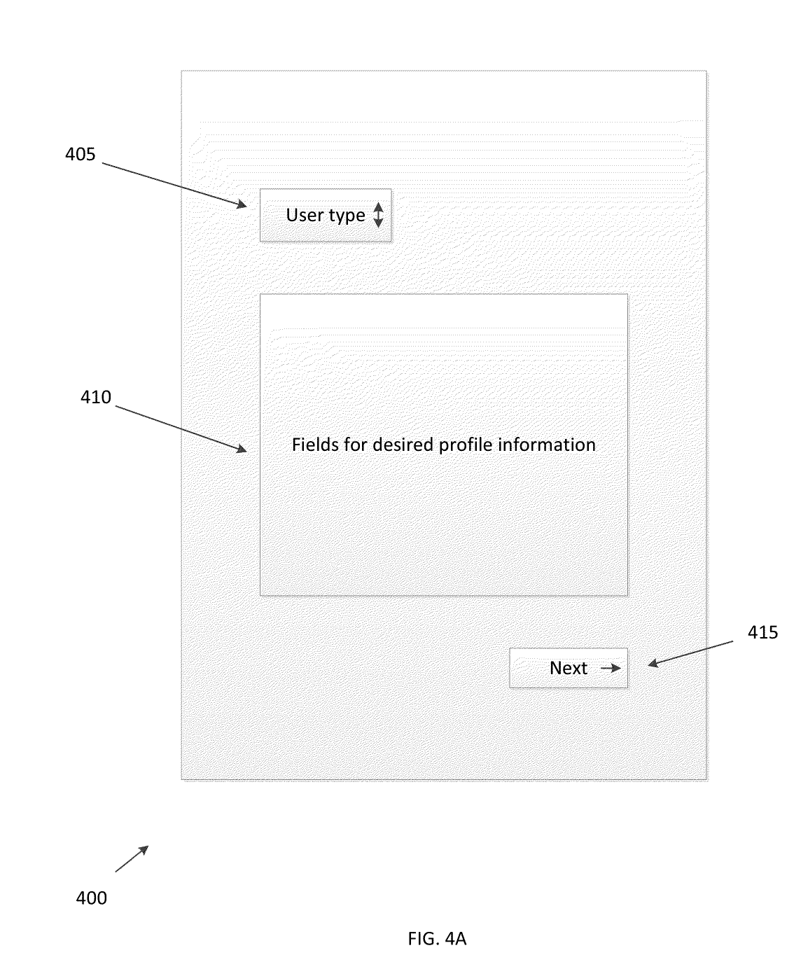

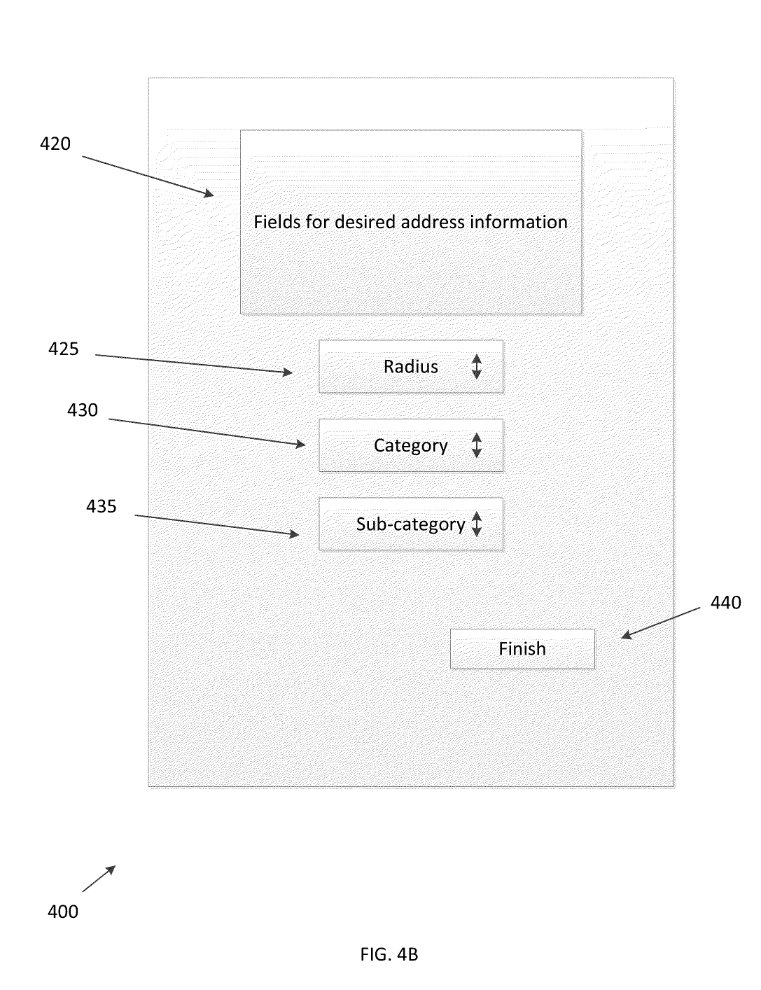

FIG. 4A is an illustration of an exemplary first screen of a registration process, by which users may register to use the software, in accordance with an embodiment of the present invention. Screens represented in figures may be accessed by any means, including, without limitation, a mobile device, computer, or tablet. In at least some embodiments, users who have already registered to use the software may have the option to log in by any determined means, including, without limitation, a registered username and password. In some embodiments, a user may register as an individual user or as a business user. In alternative embodiments, users may have further options of user types, including, without limitation, student, custom group, religious group, political group, large corporations, schools, collages, education. Other user types may include, without limitation, sales people, real-estate realtors, lawyers, professionals, politicians, journalists, political parties, and political groups. Still other user types may include, without limitation, accountants, actuaries, advocates, architects, archivists, audiologists, aviations, and business executives. Yet other user types may include, without limitation, dentists, diplomats, doctors, computer programmers, economists, engineers, and financial analysts. Still other user types may include, without limitation, information and communications technology professionals, investment bankers, journalists, lawyers, mathematicians, and military officers. Yet other user types may include, without limitation, nurses, neuroscientists, occupational therapists, optometrists, pharmacists, philosophers, physicians, pilots, professors, and psychologists. Still other user types may include, without limitation, scientists, social workers, software engineers, speech language pathologists, statisticians, surgeons, teachers, translators and interpreters, veterinarians, etc. In the present non-limiting example, user type is selected by use of spinner 405, but in alternative embodiments may be selected by means of any kind of icon. In some embodiments, certain user types may have a requirement of a fee that may be paid by users. In alternative embodiments, all user types have a fee requirement, and in other alternative embodiment, there are no fee requirements for any user types. Users may also input profile information 410. Profile information may include, without limitation, first name, last name, email address, username, and password. In some embodiments, business users may be required to submit certain profile information that other users are not required to submit, including, without limitation, phone number and business name and address. In at least some embodiments, user passwords may have certain requirements, including, without limitation, number of characters and types of characters. In some embodiments, all fields for profile information may be required to be filled. Users may be prompted to move to a next screen if there are further screens in the registration process 415.

FIG. 4B is an illustration of an exemplary second screen of the registration process, in accordance with an embodiment of the present invention. In some embodiments, users may be required to input address information 420. Address information may be used in some embodiments to determine a user's location. In at least some embodiments, users may be able to select a radius 425, by which a user may specify the area from the user's location that other users must be within in order to respond to the user's questions. In alternative embodiments, a user's specified radius may be expanded automatically by the software for an individual question if the individual question has not received responses within the specified radius after a certain amount of time. In some embodiments, a user may select a category 430 which may reflect, without limitation, the user's area of expertise, interest, etc. In at least some embodiments, only business users may be required to select a category. When a category is selected, a user may then be prompted to select a sub-category 435. In some embodiments, a user may select any number of categories 430 and sub-categories 435. After each required field has been filled, users may be prompted to finish the registration process 440.

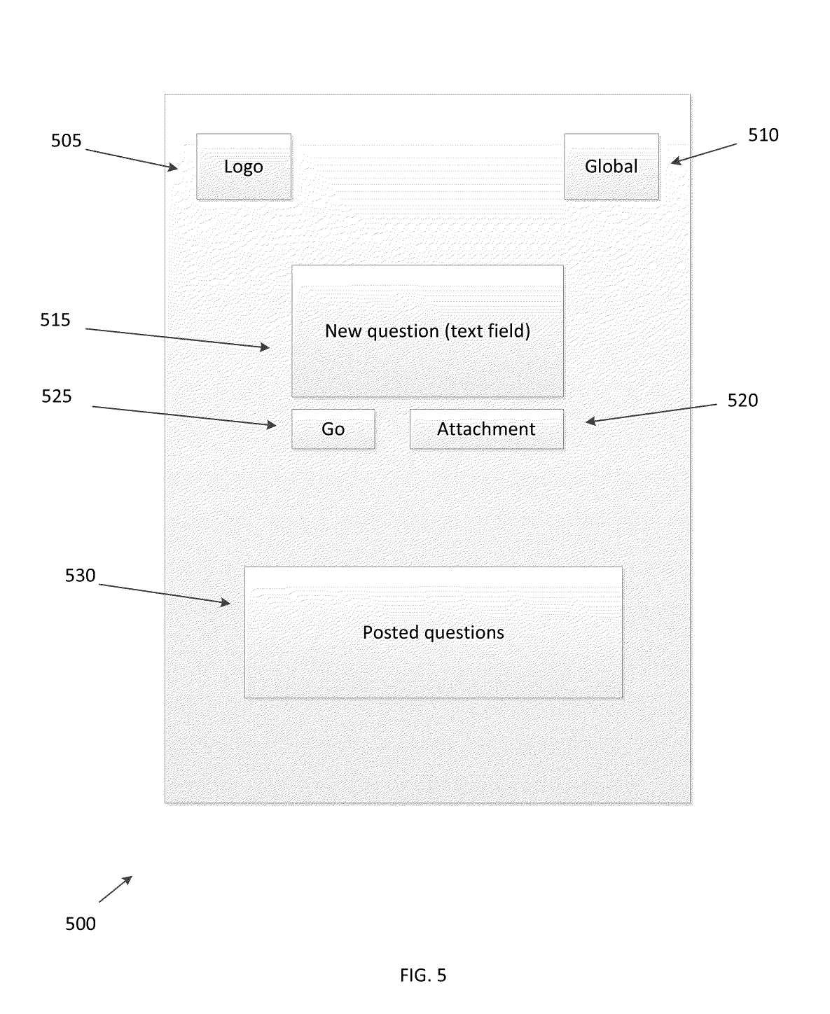

FIG. 5 is an illustration of an exemplary home screen, in accordance with an embodiment of the present invention. In the present embodiment, the home screen and/or any other screen may include a logo 505 for the software. In at least some embodiments, the logo is an icon that, when selected, may open a popup menu. In some embodiments, the software may include a “global” icon 510 on this and/or any other screen. This icon may be selected to turn global services on or off. When global services are on, a user may be able to view questions from users in any area across the globe. When global services are off, a user may only be able to view questions from users within a specified locality to the user. In some embodiments, users may be prompted to insert a question in text form 515. Users may also attach other items to the inserted text, including, without limitation, videos, audio selections, or images 520. In the present embodiment, users may select a “Go” button 525 when a question is ready, at which point a user will be shown a question preview screen. The question preview screen may allow a user to post or edit a question, open attachments, delete attachments, and select whether the question may be posted globally or locally. In some embodiments, users may post questions in the form of video, audio, image, or otherwise without the need to submit a text field 515. In at least some embodiments, users may select a category and/or sub-category for a question. In other embodiments, the software is programmed to automatically determine a category and/or sub-category for a posted question. In some alternative embodiments, the software may automatically determine a category and/or sub-category by any means, including, without limitation, the use of keywords. In a non-limiting example, tags related to each category may be stored in the database. For example, but not limited to, for the category ‘Books’, related tags may be ‘Author’, ‘Title’, etc. When a user enters a question without selecting particular category, then the application may compare the strings in that question with the tags stored in the database. If a match is found, then the corresponding category-id may be returned and the question may be saved with the category-id. In the present embodiment, users may view posted questions by other users on the home screen 530. Posted questions may include various information, including, without limitation, a question description, a user's name, a date and time when the question was posted, any attachments, and answers to the question that have been posted. In some embodiments, selecting a posted question may open a screen showing a detailed view of the selected question. In at least some embodiments, users may refresh the home screen as well as any other screen manually. In alternative embodiments, the home screen as well as any other screen may be automatically refreshed by the software at any determined intervals.

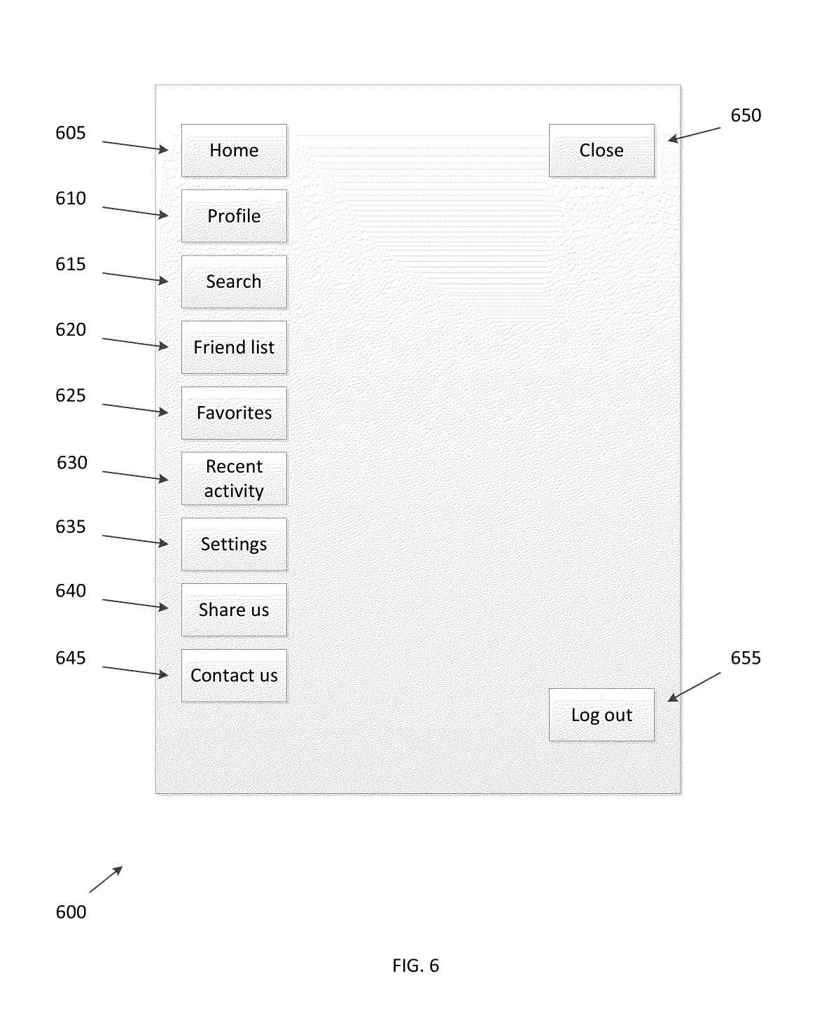

FIG. 6 is an illustration of an exemplary popup menu screen, in accordance with an embodiment of the present invention. A popup menu may show the icon and text representations of other screens that users may access. In some embodiments, the popup menu may show an icon for a home screen 605. The popup menu may also show an icon for user's profile 610. The profile icon may show the number of user's unread messages. The profile screen may contain any profile information, including, without limitation, user's profile image and profile name. In at least some embodiments, a user's profile image may be cached and saved in a secure digital (SD) card. In some embodiments, profile images on this and any other screen may be loaded by means of a lazy loading technique. In a non-limiting example, an image is loaded in a separate thread to not disturb the user interface (UI) thread too much. A new thread for each image is spawned. The downloaded images may be delivered to the UI thread. A program class takes care of loading images using threads. Also, images may be cached to avoid a single image being downloaded multiple times. A SoftReference for caching images allows a garbage collector to clean the images from the cache when needed. In a non-limiting example a programming call puts the image url to the separate thread. If the image doesn't exist in the cache yet, the image is downloaded in a separate thread and the returned to call as soon as the download is complete. If the image does exist in the cache, it is immediately returned and the method for downloading image is not called. Using this approach, a list view performs better and smoother because the UI thread is no longer blocked by the loading of images. The performance of the list view may be improved by loading images in a separate thread, by reusing rows in the list, and by caching views within a row Using the profile screen, a user may be able to edit, without limitation, user's profile information or image. The profile screen may also include, without limitation, a record of questions user has asked, questions user has answered, questions and answers that user has “liked” or “disliked”, and any messages or notifications user has received. In some embodiments, the popup menu may also show an icon for a search screen 615. Using the search screen, users may have the option of searching questions, answers, or users. The search screen may also allow users to search by category and sub-category. In some embodiments, the popup menu may also show an icon for a friend list screen 620. The friend list screen may include, without limitation, a list of friends, or users, along with each friend's profile image, and an option to search users. Selecting an individual friend may open that friend's profile screen, where a user may have options including, without limitation, sending the friend a message through the software, “following” the friend, and adding the friend as a favorite or removing the friend as a favorite. In some embodiments, the popup menu may also show an icon for a “favorites” screen 625. The favorites screen may show icons for, without limitation, a user's favorite questions, favorite answers, favorite searches, and favorite users. When the favorite questions icon is selected, a favorite questions screen may open, where a user may select individual questions and may see a detailed view of the selected question. When the favorite answers icon is selected, a favorite answers screen may open, where a user may view a list of answers which the user has marked as favorites, as well as selected profile information of a user who posted an answer. When the favorite users icon is selected, a favorite users screen may open, where a user may view a list of users which the user has marked as favorites, as well as have the option to select individual users to open that user's profile screen. In other embodiments, the popup menu may also show an icon for a “recent activity” screen 630. The recent activity screen may show icons including, without limitation, an icon to open a “recent questions” screen, an icon to open a “recent answers” screen, and an icon to open a “recent searches” screen. The recent questions screen may show a list of questions recently posted by a user, with the option to open a detailed question screen for an individual question. Users may be able to specify how recently an action must have been made in order to be included in this and other screens. Users may also have the option to clear recent activity on this and any other screen. The recent answers screen may show a list of answers recently posted by a user. The recent searches screen may show a list of recent searches on the software performed by a user. In some embodiments, the popup menu may also show an icon for a “settings” screen 635. A user may access the settings screen to make various profile changes, including, without limitation, user's category and/or sub-category, user's specified radius, and enabling or disenabling email functionality. By enabling or disenabling email functionality, a user may determine whether the software may send the user emails. The settings screen may also have an option to save any changes a user has made, as well as an option to deactivate a user's account. In some embodiments, the popup menu may also show an icon for a “share us” screen 640. The share us screen may provide an opportunity to share the software through other services, including, without limitation, facebook, twitter, email, and short message service (SMS) messaging. In at least some embodiments, users may be required to use a mobile phone with an active subscriber identity module (SIM) card in order to share by means of an SMS message. The facebook and twitter options may send a user to the individual service's authentication pages to allow an action to be performed. In some embodiments, the popup menu may also show an icon for a “contact us” screen 645. The contact us screen may provide users with an opportunity to establish contact with managers of the software. This screen may provide options including, without limitation, support services, media relations, information, and administration or investment opportunities. Users may provide personal information including, without limitation, user's name, company, email, phone number, and comments. In some embodiments, the popup menu may also show, without limitation, an icon that may be used to close the popup menu 650 and/or an icon that may be used to log out of the software 655.

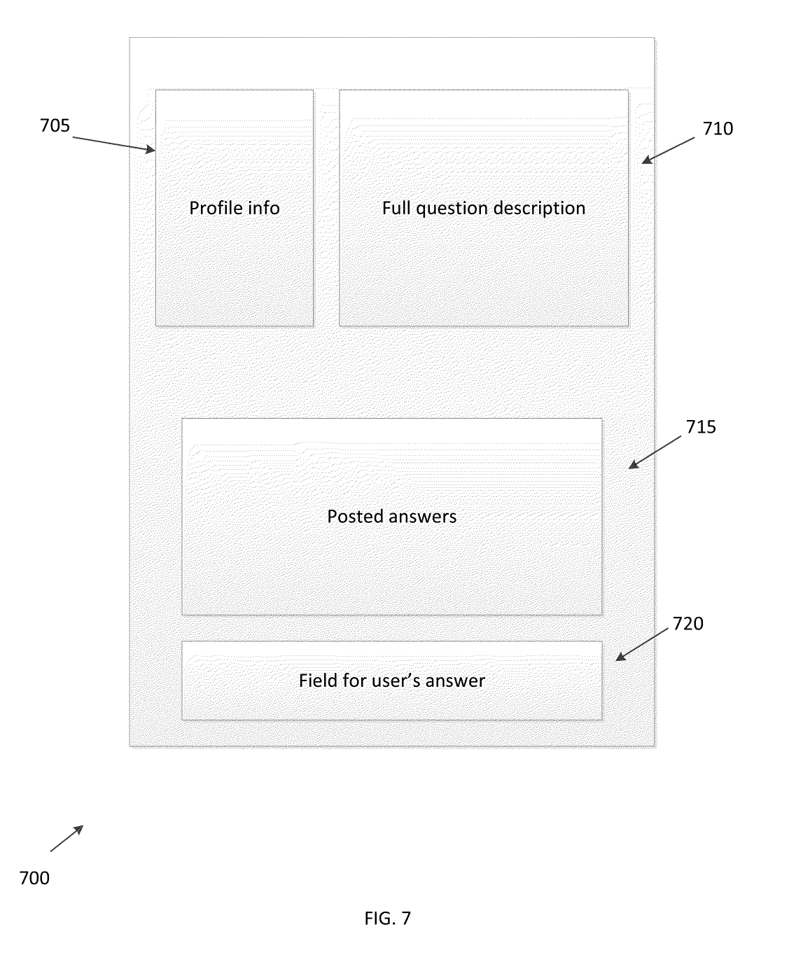

FIG. 7 is an illustration of an exemplary screen for showing a detailed view of a question, in accordance with an embodiment of the present invention. This screen may display profile information 705 of a user who posted a question, including, without limitation, the user's profile name and may also include an image of the user. A description of a question 710 may include, without limitation, the question in full or in part, a category and/or sub-category, and the time the question was posted. A list of any attachments to a question may also be shown, and users may be able to select individual attachments to open them. The screen may also show a list of answers that have been posted 715 in response to a question. In some embodiments, answers may be listed in order of time of posting. In alternative embodiments, answers may be listed by any method, including, without limitation, proximity of answerers to a user who posted a question, and the rating of answerers. Individual answers may be selected to open a detailed view of the selected answer. Any attachments may also be shown with an individual answer the attachments are attached to, and the individual attachments may be opened by users. The screen may also include, without limitation, a field by which users may provide an answer 720, along with any attachments, to a question shown in detail 710. On this and any other screen in which questions and answers are shown, users may provide feedback in various forms to individual questions and answers, including, without limitation, selecting a “star” icon to “favorite” or “unfavorite” a question or answer, selecting a “flag” icon to spam a user who posted a question or answer, selecting a “thumbs up” and/or “thumbs down” icon to provide a rating for a question or answer, and sharing a question or answer through facebook, twitter, email. SMS messaging, etc. When a question is posted and other users may see it as inappropriate they may click on the spam button, for example, but not limited to an O with a line through it. If that specific question or answer is spammed/clicked on 5 times then the question/answer may be automatically removed from the site/app software.

Some embodiments may be used as a “Forum App” where people could carry out discussions on various topics. The present ‘Question Categories/Sub-Categories’ may serve as ‘Forum Categories/Sub-Categories’. And each present ‘Question’ would be a ‘Thread’. In some embodiments, users may create new ‘Threads’ and users/friends can reply to those and share their views. Some embodiments may be used as a “Messaging App”. Utilizing the Friends/Favorites feature and the Messaging feature, Registered users may use this app to send messages to other users for free. Some embodiments may marketed in a “SAAS” model (Software As A Service) wherein the service may be sold to a particular firm (with the UI revamped to suit their company standards and branding) and users of that firm or users of products manufactured by that firm may use the app to get their issues resolved or interact with each other. All data will reside in the database server and the firm, who buys the service, may need to pay usage charges such as, but not limited to per month, per user, etc.

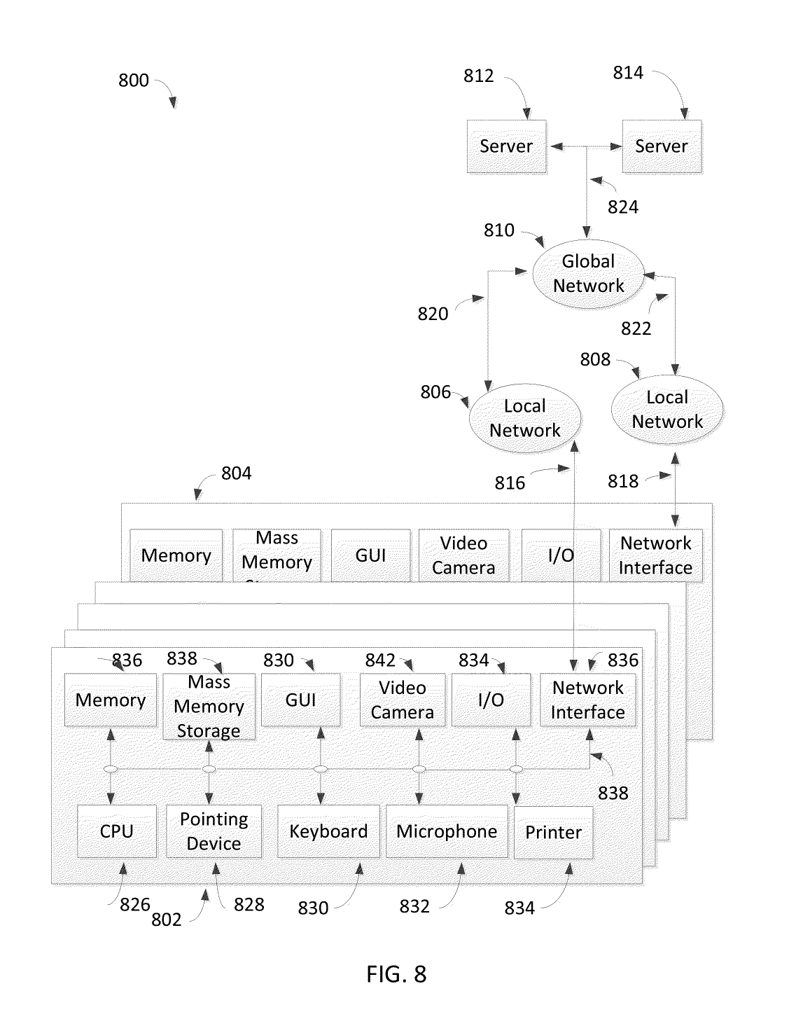

FIG. 8 is a block diagram depicting an exemplary client/server system which may be used by an exemplary web-enabled/networked embodiment of the present invention.

A communication system 800 includes a multiplicity of clients with a sampling of clients denoted as a client 802 and a client 804, a multiplicity of local networks with a sampling of networks denoted as a local network 806 and a local network 808, a global network 810 and a multiplicity of servers with a sampling of servers denoted as a server 812 and a server 814.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824. Furthermore, clients 802, 804, local networks 806, 808, global network 810 and servers 812, 814 may each communicate bi-directionally with each other.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 include personal computers, personal digital assistants (PDAs), cellular phones and smartphones.

Client 802 includes a CPU 826, a pointing device 828, a keyboard 830, a microphone 832, a printer 834, a memory 836, a mass memory storage 838, a GUI 840, a video camera 842, an input/output interface 844 and a network interface 846.

CPU 826, pointing device 828, keyboard 830, microphone 832, printer 834, memory 836, mass memory storage 838, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 836 is used typically to transfer data and instructions to CPU 826 in a bi-directional manner. Memory 836, as discussed previously, may include any suitable computer-readable media, intended for data storage, such as those described above excluding any wired or wireless transmissions unless specifically noted. Mass memory storage 838 may also be coupled bi-directionally to CPU 826 and provides additional data storage capacity and may include any of the computer-readable media described above. Mass memory storage 838 may be used to store programs, data and the like and is typically a secondary storage medium such as a hard disk. It will be appreciated that the information retained within mass memory storage 838, may, in appropriate cases, be incorporated in standard fashion as part of memory 836 as virtual memory.

CPU 826 may be coupled to GUI 840. GUI 840 enables a user to view the operation of computer operating system and software. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 and select areas or features in the viewing area of GUI 840. CPU 826 may be coupled to keyboard 830. Keyboard 830 enables a user with the capability to input alphanumeric textual information to CPU 826. CPU 826 may be coupled to microphone 832. Microphone 832 enables audio produced by a user to be recorded, processed and communicated by CPU 826. CPU 826 may be connected to printer 834. Printer 834 enables a user with the capability to print information to a sheet of paper. CPU 826 may be connected to video camera 842. Video camera 842 enables video produced or captured by user to be recorded, processed and communicated by CPU 826.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 optionally may be coupled to network interface 846 which enables communication with an external device such as a database or a computer or telecommunications or internet network using an external connection shown generally as communication channel 816, which may be implemented as a hardwired or wireless communications link using suitable conventional technologies. With such a connection, CPU 826 might receive information from the network, or might output information to a network in the course of performing the method steps described in the teachings of the present invention.

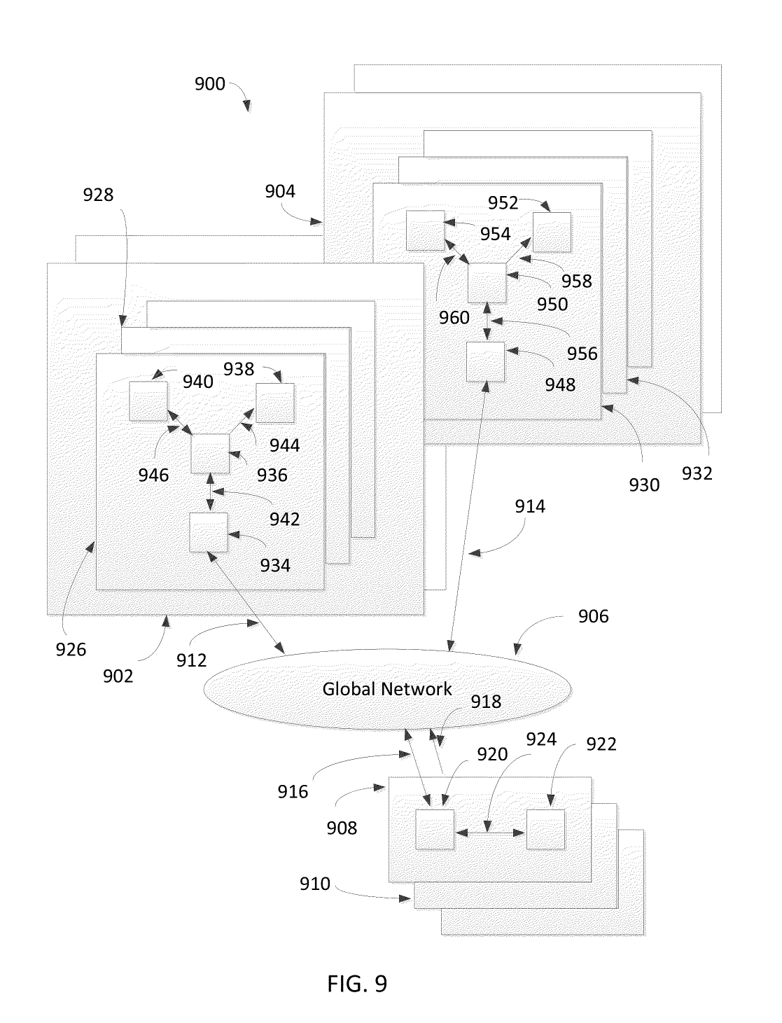

FIG. 9 illustrates a block diagram depicting a conventional client/server communication system.

A communication system 900 includes a multiplicity of networked regions with a sampling of regions denoted as a network region 902 and a network region 904, a global network 906 and a multiplicity of servers with a sampling of servers denoted as a server device 908 and a server device 910.

Network region 902 and network region 904 may operate to represent a network contained within a geographical area or region. Non-limiting examples of representations for the geographical areas for the networked regions may include postal zip codes, telephone area codes, states, counties, cities and countries. Elements within network region 902 and 904 may operate to communicate with external elements within other networked regions or within elements contained within the same network region.

In some implementations, global network 906 may operate as the Internet. It will be understood by those skilled in the art that communication system 900 may take many different forms. Non-limiting examples of forms for communication system 900 include local area networks (LANs), wide area networks (WANs), wired telephone networks, cellular telephone networks or any other network supporting data communication between respective entities via hardwired or wireless communication networks. Global network 906 may operate to transfer information between the various networked elements.

Server device 908 and server device 910 may operate to execute software instructions, store information, support database operations and communicate with other networked elements. Non-limiting examples of software and scripting languages which may be executed on server device 908 and server device 910 include C, C++, C# and Java.

Network region 902 may operate to communicate bi-directionally with global network 906 via a communication channel 912. Network region 904 may operate to communicate bi-directionally with global network 906 via a communication channel 914. Server device 908 may operate to communicate bi-directionally with global network 906 via a communication channel 916. Server device 910 may operate to communicate bi-directionally with global network 906 via a communication channel 918. Network region 902 and 904, global network 906 and server devices 908 and 910 may operate to communicate with each other and with every other networked device located within communication system 900.

Server device 908 includes a networking device 920 and a server 922. Networking device 920 may operate to communicate bi-directionally with global network 906 via communication channel 916 and with server 922 via a communication channel 924. Server 922 may operate to execute software instructions and store information.

Network region 902 includes a multiplicity of clients with a sampling denoted as a client 926 and a client 928. Client 926 includes a networking device 934, a processor 936, a GUI 938 and an interface device 940. Non-limiting examples of devices for GUI 938 include monitors, televisions, cellular telephones, smartphones and PDAs (Personal Digital Assistants). Non-limiting examples of interface device 940 include pointing device, mouse, trackball, scanner and printer. Networking device 934 may communicate bi-directionally with global network 906 via communication channel 912 and with processor 936 via a communication channel 942. GUI 938 may receive information from processor 936 via a communication channel 944 for presentation to a user for viewing. Interface device 940 may operate to send control information to processor 936 and to receive information from processor 936 via a communication channel 946. Network region 904 includes a multiplicity of clients with a sampling denoted as a client 930 and a client 932. Client 930 includes a networking device 948, a processor 950, a GUI 952 and an interface device 954. Non-limiting examples of devices for GUI 938 include monitors, televisions, cellular telephones, smartphones and PDAs (Personal Digital Assistants). Non-limiting examples of interface device 940 include pointing devices, mousse, trackballs, scanners and printers. Networking device 948 may communicate bi-directionally with global network 906 via communication channel 914 and with processor 950 via a communication channel 956. GUI 952 may receive information from processor 950 via a communication channel 958 for presentation to a user for viewing. Interface device 954 may operate to send control information to processor 950 and to receive information from processor 950 via a communication channel 960.

For example, consider the case where a user interfacing with client 926 may want to execute a networked application. A user may enter the IP (Internet Protocol) address for the networked application using interface device 940. The IP address information may be communicated to processor 936 via communication channel 946. Processor 936 may then communicate the IP address information to networking device 934 via communication channel 942. Networking device 934 may then communicate the IP address information to global network 906 via communication channel 912. Global network 906 may then communicate the IP address information to networking device 920 of server device 908 via communication channel 916. Networking device 920 may then communicate the IP address information to server 922 via communication channel 924. Server 922 may receive the IP address information and after processing the IP address information may communicate return information to networking device 920 via communication channel 924. Networking device 920 may communicate the return information to global network 906 via communication channel 916. Global network 906 may communicate the return information to networking device 934 via communication channel 912. Networking device 934 may communicate the return information to processor 936 via communication channel 942. Processor 996 may communicate the return information to GUI 998 via communication channel 944. User may then view the return information on GUI 938.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation, posting text, audio, video, and images online, location-based services, and navigating all facets of the software.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing internet services according to the present invention will be apparent to those skilled in the art. Various aspects of the invention have been described above by way of illustration, and the specific embodiments disclosed are not intended to limit the invention to the particular forms disclosed. The particular implementation of the internet services may vary depending upon the particular context or application. By way of example, and not limitation, the internet services described in the foregoing were principally directed to internet communication implementations; however, similar techniques may instead be applied to any internet transfer system, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
establishing a communication with a server;
transmitting a location of a user to said server;
transferring a user's question to said server, said question comprising text and at least one multimedia component, said server being configured to be operable for enabling other users, located within a predetermined distance from said location, to receive said question and to post a reply to said question, said server being further configured to be operable for storing replies to said question and sending at least one notification to the user that replies have been received; and
receiving said at least one notification from said server.

2. The method as recited in claim 1, further comprising the step of transferring to said server a user's selection for said predetermined distance.

3. The method as recited in claim 1, further comprising the step of transferring to said server a user's request for a global viewing of said question where said server enables all other users to receive said question.

4. The method as recited in claim 1, further comprising the step of transferring to said server a user's chosen category of interest for said question where said server enables other users to receive said question under a listing of said category.

5. The method as recited in claim 4, further comprising the step of transferring to said server a user's chosen sub-category of interest for said question where said server enables other users to receive said question under a listing of said sub-category of said category.

6. The method as recited in claim 1, in which said server categorizes said question at least in part based on said text where said server enables other users to receive said question under a listing of said categorization.

7. The method as recited in claim 1, in which said location is at least in part determined by a global positioning system.

8. The method as recited in claim 1, in which said multimedia component comprises a video file, an audio file or a picture file.

9. The method as recited in claim 1, further comprising the step of transferring said question or a posted rely to an external social site for sharing.

10. A system comprising:
a client application being configured to be operable to establish a communication over a network, transmit a location of a user over the network, transfer a user's question over the network, said question comprising text and at least one multimedia component, and receive at least one notification of posted replies to said question; and
a serve being configured to be operable to receive said location and said question, said server being further configured to be operable to enable other users, located within a predetermined distance from said location, to receive said question and to post a reply to said question, said server being further configured to be operable to store replies to said question and to send at least one notification to the user that replies have been received.

11. The system as recited in claim 10, in which said client application is further configured to be operable to determine said location at least in part by using a global positioning system, said client application is further configured to be operable to attach said multimedia component comprising a video file, an audio file or a picture file to said text, said client application is further configured to be operable to transfer a user's selection for said predetermined distance, a user's request for a global viewing of said question, a user's chosen category of interest for said question, a user's chosen sub-category of interest for said question, said client application is further configured to be operable to transfer said question or a posted rely to an external social site for sharing; and
said server is further configured to be operable to receive the user's selection for said predetermined distance, the user's request for a global viewing of said question where said server enables all other users to receive said question, the user's chosen category of interest for said question where said server enables other users to receive said question under a listing of said category, the user's chosen sub-category of interest for said question where said server enables other users to receive said question under a listing of said sub-category of said category, said server is further configured to be operable to categorize said question at least in part based on said text where said server enables other users to receive said question under a listing of said categorization.

12. A non-transitory computer-readable storage medium with an executable program stored thereon, wherein the program instructs a processor to perform the following steps:
establishing a communication with a server;
transmitting a location of a user to said server;
transferring a user's question to said server, said question comprising text and at least one multimedia component, said server being configured to be operable for enabling other users, located within a predetermined distance from said location, to receive said question and to post a reply to said question, said server being further configured to be operable for storing replies to said question and sending at least one notification to the user that replies have been received; and
receiving said at least one notification from said server.

13. The program instructing the processor as recited in claim 12, further comprising the step of transferring to said server a user's selection for said predetermined distance.

14. The program instructing the processor as recited in claim 12, further comprising the step of transferring to said server a user's request for a global viewing of said question where said server enables all other users to receive said question.

15. The program instructing the processor as recited in claim 12, further comprising the step of transferring to said server a user's chosen category of interest for said question where said server enables other users to receive said question under a listing of said category.

16. The program instructing the processor as recited in claim 15, further comprising the step of transferring to said server a user's chosen sub-category of interest for said question where said server enables other users to receive said question under a listing of said sub-category of said category.

17. The program instructing the processor as recited in claim 12, in which said server categorizes said question at least in part based on said text where said server enables other users to receive said question under a listing of said categorization.

18. The program instructing the processor as recited in claim 12, in which said location is at least in part determined by a global positioning system.

19. The program instructing the processor as recited in claim 12, in which said multimedia component comprises a video file, an audio file or a picture file.

20. The program instructing the processor as recited in claim 12, further comprising the step of transferring said question or a posted rely to an external social site for sharing.
